(19) United States
(12) Patent Application Publication
(10) Pub. No.: US 2025/0001505 A1
(43) Pub. Date: Jan. 2, 2025

(54) POWDER BED FUSION ADDITIVE PRINTER RECOATER FOR UNIFORM POWDER PACKING

(71) Applicant: RTX Corporation, Farmington, CT (US)

(72) Inventors: Lawrence Binek, Glastonbury, CT (US); Jesse Boyer, Middletown, CT (US)

(21) Appl. No.: 18/758,524

(22) Filed: Jun. 28, 2024

Related U.S. Application Data
(60) Provisional application No. 63/511,474, filed on Jun. 30, 2023.
(60) Provisional application No. 63/511,479, filed on Jun. 30, 2023.
(60) Provisional application No. 63/511,482, filed on Jun. 30, 2023.
(60) Provisional application No. 63/511,486, filed on Jun. 30, 2023.
(60) Provisional application No. 63/518,741, filed on Aug. 10, 2023.

(51) Int. Cl. B22F 12/60; B22F 10/28; B22F 10/73; B22F 12/37; B22F 12/45; B33Y 10/00; B33Y 30/00

(52) U.S. Cl. CPC B22F 12/60; B22F 10/28; B22F 10/73; B22F 12/37; B22F 12/45; B33Y 10/00; B33Y 30/00

(57) ABSTRACT

A powder bed fusion (PBF) additive manufacturing system includes a powder delivery mechanism configured to deliver build powder to a build area of an annular build plate to form a build powder bed while the annular build plate rotates when the PBF additive manufacturing system is in operation and a recoater configured to provide a uniform density of power packing of the build powder in the build powder bed while the annular build plate rotates when the PBF additive manufacturing system is in operation. The recoater has at least one segment positioned at an acute angle relative to an axis perpendicular to a direction of rotation of the annular build plate.

### CROSS-REFERENCE TO RELATED APPLICATIONS

This application claims the benefit of U.S. Provisional Application 63/511,474 filed Jun. 30, 2023 for “POWDER BED FUSION ADDITIVE PRINTER ARCHITECTURE FOR ANNULAR GEOMETRIES;” U.S. Provisional Application 63/511,479 filed Jun. 30, 2023 for “POWDER BED FUSION ADDITIVE PRINTER BUILD HEAD;” U.S. Provisional Application 63/511,482 filed Jun. 30, 2024 for “POWDER BED FUSION ADDITIVE PRINTER WITH INTEGRATED INSPECTION;” U.S. Provisional Application 63/511,486 filed Jun. 30, 2023 for “POWDER BED FUSION ADDITIVE PRINTER FOR PARTS WITH HELICAL SLICES;” U.S. Provisional Application 63/518,741 filed Aug. 10, 2023 for “POWDER BED FUSION ADDITIVE PRINTER BUILD PLATFORM DRIVE MECHANISM,” the disclosures of which are hereby incorporated by reference in their entireties. This application is also related to U.S. Attorney Docket No. 180881US01-U373-P15682US1 filed on even date herewith for “SHROUDED BUILD PLATE FOR POWDER BED FUSION ADDITIVE PRINTER,” and U.S. Attorney Docket No. 181028US01-U373-P15699US1 filed on even date herewith for “POWDER BED FUSION ADDITIVE PRINTER RECOATER FOR UNIFORM POWDER PACKING,” the disclosures of which are hereby incorporated by reference in their entireties.

### BACKGROUND

The present disclosure relates generally to powder bed fusion additive manufacturing and, more particularly, to a powder bed fusion additive manufacturing drive mechanism for annular geometries.

Powder bed fusion (PBF) additive manufacturing is an additive manufacturing, or 3-D printing, technology that uses a laser or other energy source such as an electron beam to sinter or fuse metallic or polymeric particles together in a layer-by-layer process. PBF is typically used as an industrial process to make near net shape parts. Some PBF processes sinter the build powder particles, while others melt and fuse the build powder particles. Laser Powder Bed fusion (PBF-LB) is also known as direct metal laser sintering (DMLS).

Build plates serve as a foundation upon which a PBF build (i.e., the “workpiece” or “part”) is built. Build plates for PBF additive manufacturing systems typically have a rectangular, square, or circular geometry, which provides the flexibility to support a wide variety of build shapes. As parts being made with PBF additive manufacturing processes get bigger, though, rectangular, square, or circular build plates present some disadvantages for builds having an annular shape. The disadvantages include the volume of unconsolidated (i.e., unused) powder that accumulates in the annulus of the annular-shaped build, the amount of time required to recoat the build plate with fresh build powder, and the amount of time required to raster the build head across the build plate. While it might be possible to reuse the unconsolidated powder for other purposes, reuse can be cumbersome. Accordingly, the relatively large amount of unconsolidated powder associated with annular-shaped builds, the time spent recoating the build plate, and the time spent rastering the build head over the build plate represent “waste” factors in the manufacturing process that would be preferable to avoid.

### SUMMARY

One aspect of this disclosure is directed to a powder bed fusion (PBF) additive manufacturing system including a powder delivery mechanism configured to deliver build powder to a build area of an annular build plate to form a build powder bed while the annular build plate rotates when the PBF additive manufacturing system is in operation and a recoater configured to provide a uniform density of power packing of the build powder in the build powder bed while the annular build plate rotates when the PBF additive manufacturing system is in operation. The recoater has at least one segment positioned at an acute angle relative to an axis perpendicular to a direction of rotation of the annular build plate.

Yet another aspect of this disclosure is directed to a build head for a powder bed fusion (PBF) additive manufacturing system including a powder delivery mechanism configured to deliver build powder to a build area of an annular build plate to form a build powder bed while the annular build plate rotates when the PBF additive manufacturing system is in operation, a recoater configured to provide a uniform density of power packing of the build powder in the build powder bed while the annular build plate rotates when the PBF additive manufacturing system is in operation, wherein the recoater comprises at least one segment positioned at an acute angle relative to an axis perpendicular to a direction of rotation of the annular build plate, and an optical array positioned over the build area on the build plate, wherein the optical array is configured to project energy onto the build powder bed to form a melt pool in the build powder bed while the annular build plate rotates when the PBF additive manufacturing system is in operation.

Yet another aspect of this disclosure is directed to a method of operating a powder bed fusion (PBF) additive manufacturing system including providing in the PBF additive manufacturing system a build head that has a powder delivery mechanism configured to deliver build powder to a build area of an annular build plate to form a build powder bed while the annular build plate rotates when the PBF additive manufacturing system is in operation, a recoater configured to provide a uniform density of power packing of the build powder in the build powder bed while the annular build plate rotates when the PBF additive manufacturing system is in operation, wherein the recoater comprises at least one segment positioned at an acute angle relative to an axis perpendicular to a direction of rotation of the annular build plate, and an optical array positioned over the build area on the build plate, wherein the optical array is configured to project energy onto the build powder bed to form a melt pool in the build powder bed while the annular build plate rotates when the PBF additive manufacturing system is in operation. The powder delivery mechanism delivers build powder to the build area to form a build powder bed while the build plate rotates. A recoater distributes the build powder in the build powder bed to provide uniform density of power packing of the build powder in the build powder bed while the build plate rotates. The optical array positioned over the build area on the build plate directs energy to the build powder in the build powder bed to form a melt pool in the build powder bed while the build plate rotates. Energy from the optical array is used to selectively sinter build powder from the melt pool to form a layer of a consolidated part while the build plate rotates.

### BRIEF DESCRIPTION OF THE DRAWINGS

FIG. 1 is an illustration of one type of annular-shaped build that can be made with a powder bed fusion (PBF) additive manufacturing system.

FIG. 2A is an overhead schematic of a PBF additive manufacturing system having an annular-shaped build plate.

FIG. 2B is an overhead schematic of a PBF additive manufacturing system having an annular-shaped built plate with apertures to collect excess build powder.

FIG. 2C is a cross-section of FIG. 2B along line B-B.

FIG. 3 is an elevation schematic of a PBF additive manufacturing system having an annular-shaped build plate.

FIG. 4 is an elevation schematic of a build piston of a PBF additive manufacturing system having an annular-shaped build.

FIG. 5 is an elevation schematic of the build piston of FIG. 4 showing a worm gear screw, bearing sleeve, and worm gear drive.

FIG. 6 is an elevation schematic of the build piston of FIG. 4 showing linear actuators to control the vertical translation and rotation of the drive shaft.

FIG. 7A is a schematic of a build head for use in a PBF additive manufacturing system having an annular-shaped build plate.

FIG. 7B is a schematic of a one configuration of a recoater for use in a PBF additive manufacturing system having an annular-shaped build plate.

FIG. 7C is a schematic of a another configuration of a recoater for use in a PBF additive manufacturing system having an annular-shaped build plate.

FIG. 7D is a schematic of a recoater having a constant sharp edge for use in a PBF additive manufacturing system having an annular-shaped build plate.

FIG. 7E is a schematic of a recoater having a constant radiused edge for use in a PBF additive manufacturing system having an annular-shaped build plate.

FIG. 7F is a schematic of a chevron-shaped recoater for use in a PBF additive manufacturing system having an annular-shaped build plate.

FIG. 7G is an overhead view of the hybrid recoater of FIG. 7E on a PBF additive manufacturing system having an annular-shaped build plate.

FIG. 7H is a schematic of a hybrid configuration of a recoater for use in a PBF additive manufacturing system having an annular-shaped build plate.

FIG. 7I is a schematic of the hybrid recoater of FIG. 7H overlaid on the cross-section of FIG. 2C.

FIG. 7J is an overhead view of the hybrid recoater of FIG. 7H on a PBF additive manufacturing system having an annular-shaped build plate.

FIG. 8 is a schematic of an optical head array for use in a PBF additive manufacturing system having an annular-shaped build plate of the subject disclosure.

FIG. 9 is a graph showing a zone of preferred operating conditions for a PBF additive manufacturing system having an annular-shaped build plate.

FIG. 10 is a schematic of an integrated X-ray CT scanner for use in a PBF additive manufacturing system having an annular-shaped build plate.

FIG. 11 is a schematic representation of a part built using conventional, layer-by-layer PBF additive manufacturing process.

FIG. 12 is another schematic representation of a part built using conventional, layer-by-layer PBF additive manufacturing process.

FIG. 13 is a schematic representation of a part built using the disclosed, continuous helical layer PBF additive manufacturing process.

FIG. 14 is another schematic representation of a continuous helical layer formed with the disclosed PBF additive manufacturing process.

### DETAILED DESCRIPTION

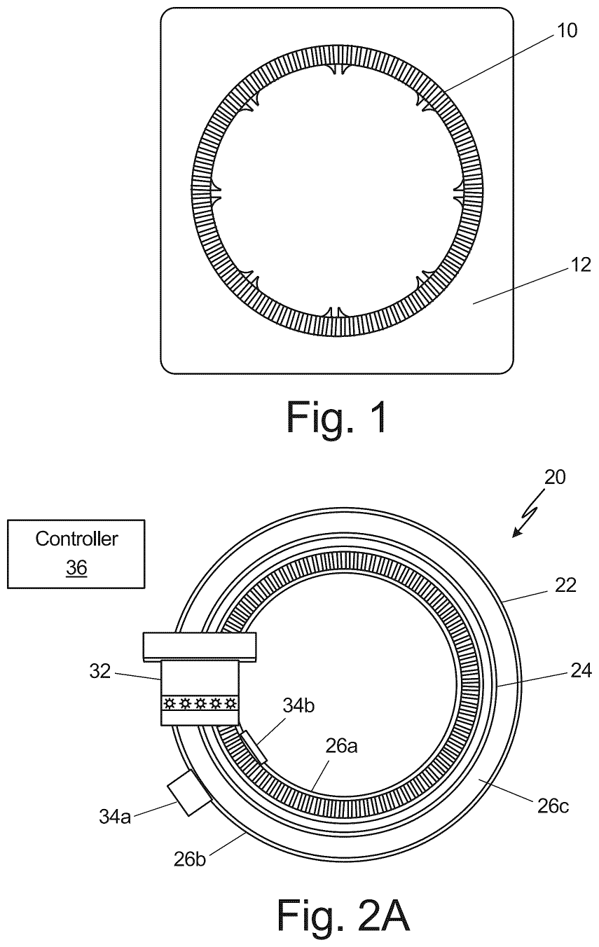

Powder bed fusion (PBF) additive manufacturing is an option to make near net shape parts with various geometries. Parts having an annular shape-particularly those with relatively large diameters can be a challenge. Examples of such annular-shaped parts include parts for gas turbine engines (e.g., compressor stages, turbine stages, combustor cans and combustion chambers, cases, etc.), other aerospace applications, and numerous commercial applications. FIG. 1 shows a non-limiting, exemplary gas turbine engine compressor stage 10 made using a PBF additive manufacturing process. Parts such as the gas turbine engine compressor stage 10 and other parts can be valuable for original equipment assemblies and for in-service sustainment requirements. Generally, annular-shaped parts, such as the gas turbine engine compressor stage 10, can be printed in their entirety in a large format PBF additive manufacturing machine. Because the part envelope of conventional large format machines is typically rectangular, square, or circle shaped with correspondingly shaped rectangular, square, or circular build plates 12, such machines are not ideal for annular-shaped parts because the annulus of annular-shaped parts results in a large area of unconsolidated build powder within the annular ring. Depending on the PBF additive manufacturing process used to make such parts, the large area of unconsolidated build powder can end up being “wasted,” which drives up the expense of making such parts with conventional PBF additive manufacturing methods. Accordingly, there is often not a business case to support using conventional PBF additive manufacturing methods for annular-shaped parts.

In addition to challenges with efficient use of build powder when using conventional PBF additive manufacturing methods for annular-shaped parts, the cycle time for large format conventional PBF additive manufacturing systems can be challenging. The architecture of conventional PBF additive manufacturing systems requires that the energy source (e.g., laser or electron beam) track the rectilinear cartesian coordinates of the part on the rectangular or square build plates. For annular-shaped parts, this means that the energy source in a conventional PBF additive manufacturing system spends significant time tracking over portions of the build powder bed that will not be consolidated to make the annular-shaped parts. As a result, a significant portion of the build time for such parts is non-productive in that the energy source is tracking over the build powder bed without consolidating any of the build powder. The large amount of non-productive build time is another type of “waste” that further drives up the expense of making such parts with conventional PBF additive manufacturing methods.

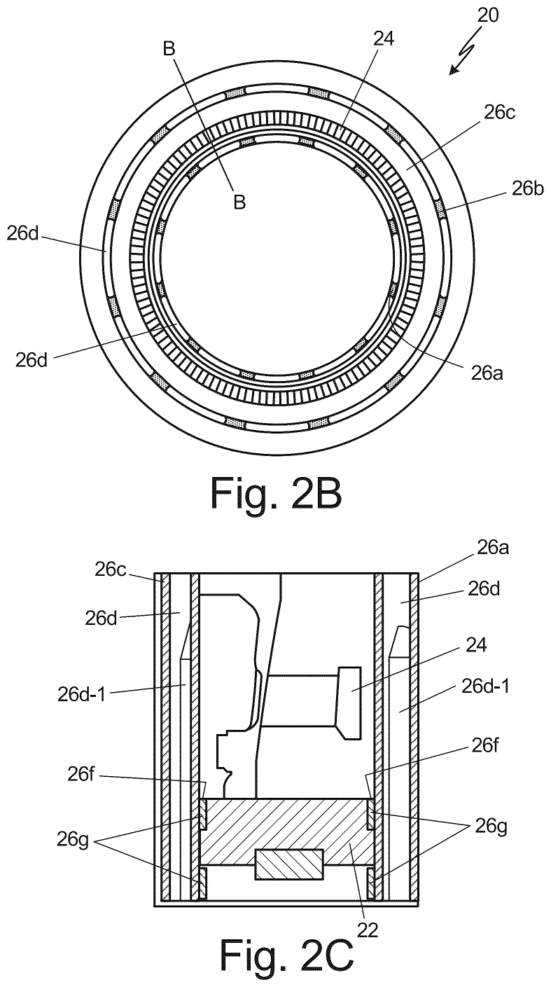

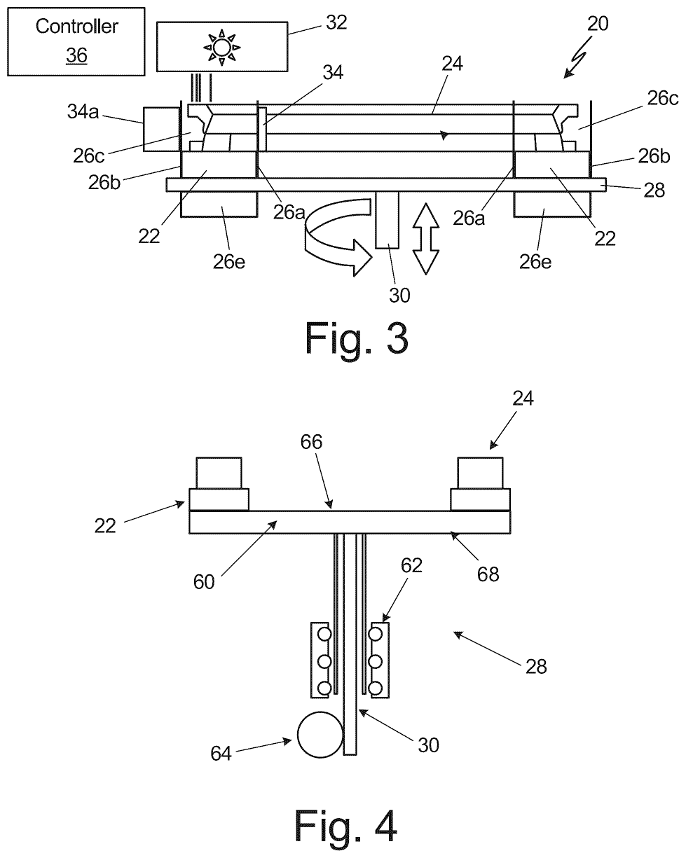

As shown in FIGS. 2A and 3, this application discloses a PBF additive manufacturing system 20 and a PBF additive manufacturing drive mechanism system that replaces the conventional rectangular or square build plate with a rotating annular build plate 22 for making annular-shaped parts 24. The rotating annular build plate 22 is surrounded by walls (or shrouds) 26, including inner radius walls/shrouds 26a and outer radius walls/shrouds 26b, to define a build area 26c that contains a powder bed (not shown) of build powder during the PBF additive manufacturing process and positioned on a build piston 28. The walls/shrouds 26 extend vertically from a junction 26f (see FIG. 2C) with the build plate 22 to define the build area 26c. The build piston 28 is configured to rotate the build plate 22 and walls/shrouds 26 in a continuous circular motion and to translate down as the PBF additive manufacturing process progresses to form part 24. The build plate 22 moves in concert with the build piston 28. The rotation and downward translation of the build piston 28 and build plate 22 allows for the part 24 to build up without stepping or interruption. As described in more detail below, the part 24 can be formed from a continuous, helical layer of consolidated build powder that overlays itself as the part 24 is built.

FIG. 2B is a schematic of the build plate 22 discussed above showing more detail of the walls/shrouds 26. As shown in FIG. 2B, each of the inner radius walls/shrouds 26a and outer radius walls/shrouds 26b include a plurality of apertures 26d. The plurality of apertures 26d arc configured to collect excess build powder distributed over the build area 26c by the recoater 42 as discussed below. The plurality of apertures 26d are further configured to direct the excess build powder through the inner radius walls/shrouds 26a and outer radius walls/shrouds 26b to an excess build powder reservoir 26e (see FIG. 3) located below the build plate 22. The plurality of apertures 26d may include any number of apertures 26d appropriate for a particular application and may have any appropriate shape, such as the elongated oval shape shown in FIG. 2B or any other appropriate shape.

FIG. 2C shows a cross-section of the build plate 22 along line B-B of FIG. 2B. FIG. 2C shows that the plurality of apertures 26d extend through a vertical length of the inner radius walls/shrouds 26a and outer radius walls/shrouds 26b to direct excess build powder to the excess build powder reservoir 26e. Depending on the application, the plurality of apertures 26d can include one or more internal dividers 26d-1 to facilitate flow of excess build powder through the plurality of apertures 26d. The one or more internal dividers 26d-1 can have any appropriate geometry (e.g., chamfered, etc.) and may extend for some or all of the vertical length of the plurality of apertures 26d. A plurality of seals 26g positioned between the inner radius walls/shrouds 26a and outer radius walls/shrouds 26b and the build plate 22 are configured to prevent build powder migrating out of the build area 26c through the junction 26f between the inner radius walls/shrouds 26a and outer radius walls/shrouds 26b and the build plate 22. The seals 26g can be made from any material and have any design appropriate for performing their intended function.

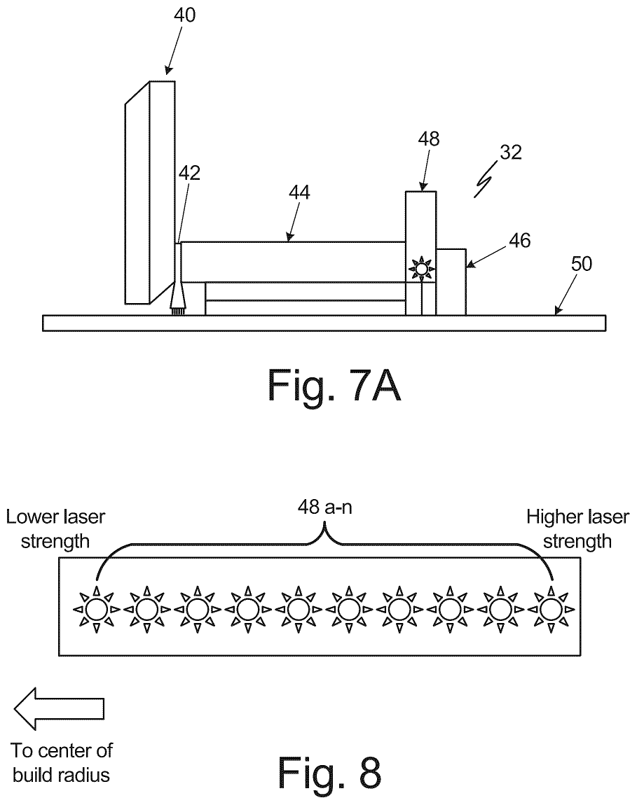

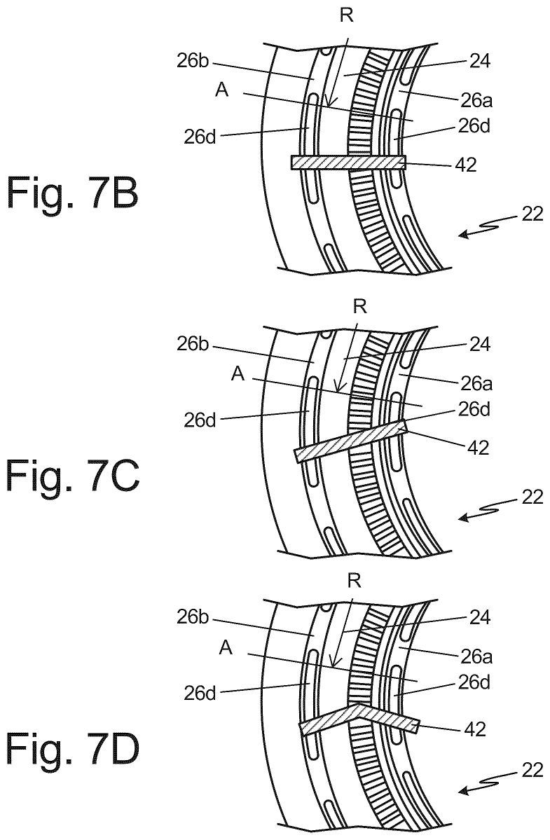

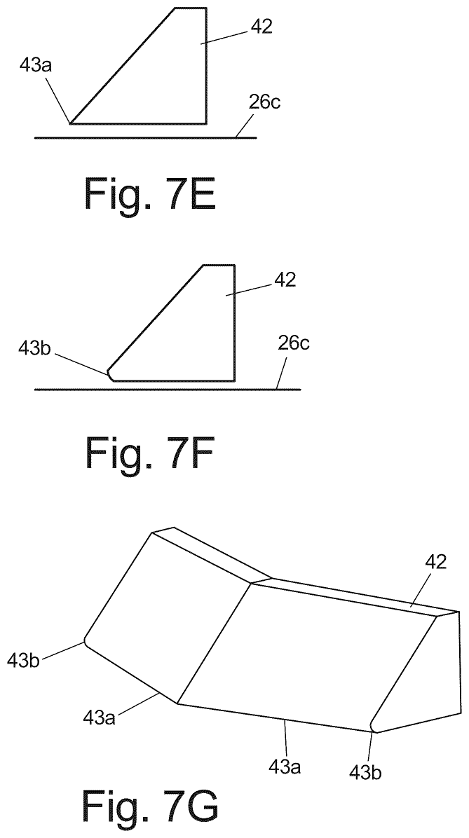

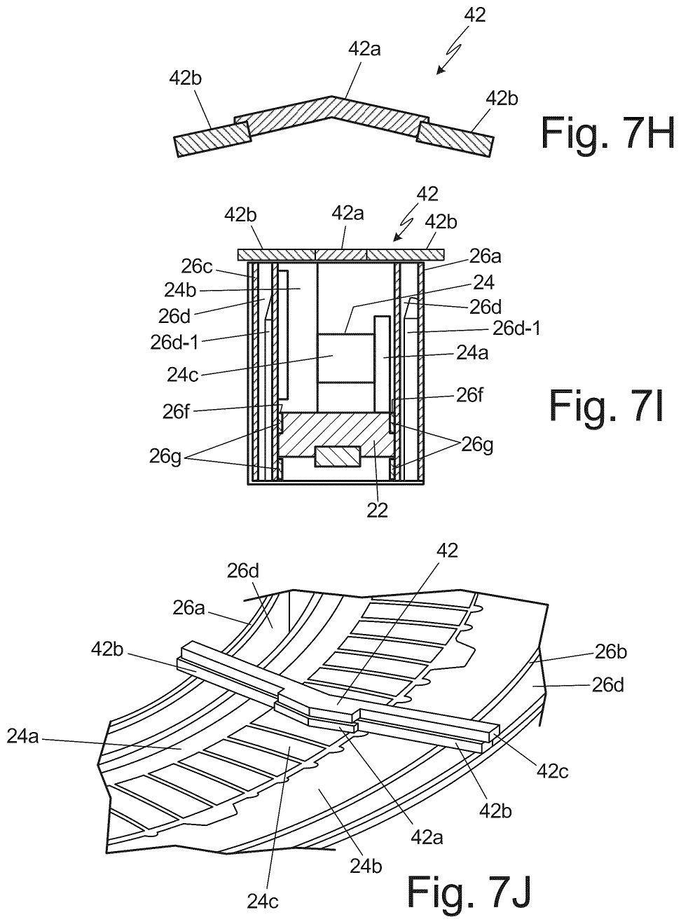

FIG. 3 shows excess build powder reservoir 26e in schematic form. While FIG. 3 shows excess build powder reservoir 26e mounted to build piston 28, the excess build powder reservoir 26c can be mounted in any location and on any structure that permits collection of excess build powder captured by the plurality of apertures 26b and directed to the excess build powder reservoir 26e when the PBF additive manufacturing system 20 is in operation. Excess build powder captured in the excess build powder reservoir 26e can be handled in a variety of ways. For example, the excess build powder can be analyzed for potential reuse on the PBF additive manufacturing system 20, on another PBF additive manufacturing system, or for some other purpose. Depending on the design of the PBF additive manufacturing system 20, the excess build powder can be recycled to the powder dispensing mechanism 40 (see FIG. 7) for reuse in the same build campaign from which the excess build powder was collected. If the excess build powder captured in the excess build powder reservoir 26e is not deemed fit for reuse, the excess build powder can be discarded using appropriate disposal methods.

FIG. 4 is a more detailed schematic of the build piston 28 discussed above. The build piston 28 includes a build platform 60, a drive shaft 30, a bearing sleeve 62, and a drive shaft actuation mechanism 64. The build platform 60 includes a top portion 66 that engages with the build plate 22 and a bottom portion 68 that engages with the drive shaft 30. One end of the drive shaft 30 is attached to the build platform 60 at or near the bottom portion 68 of the build platform 60. The drive shaft 30 can be attached to the build platform 60 at or near the center of the bottom portion 68 of the build platform 60 to facilitate rotation of the build platform 60. The drive shaft 30 transmits drive forces from the drive shaft actuation mechanism 64 to the build platform 60 to cause the build platform 60 to rotate and translate vertically. The bearing sleeve 62 surrounds the drive shaft 30 and ensures linear alignment of the drive shaft 30. The bearing sleeve 62 may include any type of bearing suitable to ensure smooth rotation and linear alignment of the drive shaft 30, for example, ball bearings, roller bearings, and other types of bearings. The drive shaft actuation mechanism 64 is configured to rotate the drive shaft at a rate, which can be a continuous rate, that is coordinated with, and in some examples, coupled to the drive shaft 30 rate of vertical translation, to move the build platform 60 helically. The drive shaft 30 can also be configured to be removable from the build piston 28 so that a different configuration of drive shaft 30 can be used depending on a desired helical layer structure of the part 24 (see the discussion below) being produced by the PBF additive manufacturing system 20.

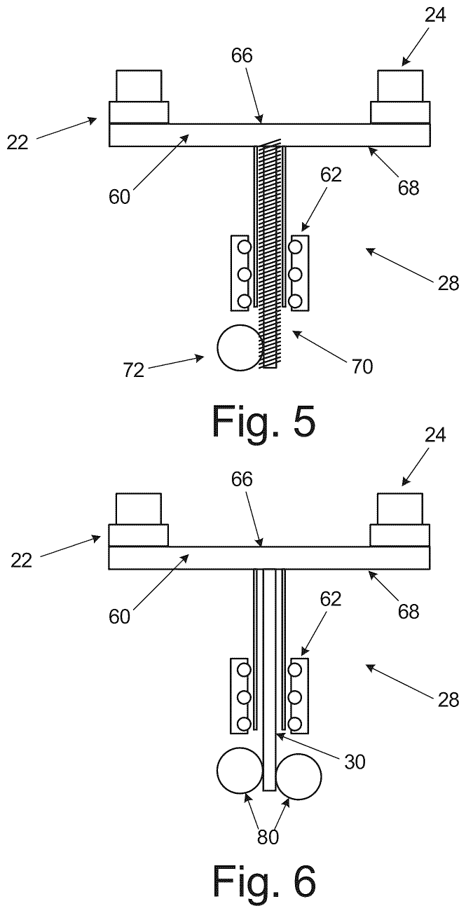

FIG. 5 is a schematic of another example of the build piston 28 of this disclosure, where the drive shaft 30 includes a worm gear screw 70 and the drive shaft actuation mechanism 64 includes a worm gear drive 72. As discussed above, the bearing sleeve 62 ensures smooth rotation and linear alignment of the worm gear screw 70. The worm gear screw 70 has a helically structured threading with a pitch, pitch angle, thread angle, and diameter that is appropriate to achieve a desired helical layer structure of the part 24 being produced by the PBF additive manufacturing system 20 (see the description below of the helical layer structure of the part 24). The worm gear screw 70 pitch, pitch angle, and thread angle, can be constant or variable across the length of the worm gear screw 70, depending on the desired helical layer structure of the part 24 being produced by the PBF additive manufacturing system 20. The worm gear drive 72 can be configured to rotate at a constant or variable speed in a clockwise or counterclockwise direction, depending on the desired helical layer structure of the part 24 being produced by the PBF additive manufacturing system 20. The worm gear drive 72 can be decoupled from the worm gear screw 70 and exchanged for a worm drive 72 with a different drive diameter and/or pattern of threading to alter the helical layer structure of the part 24 being produced by the PBF additive manufacturing system 20.

FIG. 6 is a schematic of another example of the build piston 28 of this disclosure, where the drive shaft actuation mechanism 64 includes linear actuators 80 configured to rotate the drive shaft 30 and translate the drive shaft 30 vertically. The rotation and vertical translation of the drive shaft 30 can be configured to be independent from each other or can be coupled to each other. The speed and direction at which the linear actuators 80 move the drive shaft 30 can be variable and is selected to generate a desired helical layer structure of the part 24 being produced by the PBF additive manufacturing system 20. In some examples, the linear actuators 80 can be configured to uncouple their rate of rotation and rate of vertical translation temporarily to achieve a desired helical layer structure of the part 24 being produced by the PBF additive manufacturing system 20. Additionally, the examples of FIGS. 5 and 6 can be combined such that an example includes a worm gear screw 70 as the drive shaft 30 and both a worm gear drive 72 and linear actuators 80 as the drive shaft actuation mechanism 64. In this example, either the worm gear drive 72 or the linear actuators 80 can engage to drive the drive shaft 30 at any given time so that both the worm gear drive 72 and the linear actuators 80 are not driving the drive shaft 30 at the same time. In this example, the worm gear drive 72 and the linear actuators 80 can both include the full range of features as discussed above.

The PBF additive manufacturing system 20 can also include a multi-function build head 32 positioned at a predetermined height over the build area 26c that includes powder delivery mechanism, a recoater, a build powder preheater, a gas manifold, and an optical array as described in more detail below (see FIGS. 7A and 8). Alternately, each element of the multi-function build head 32 can be provided independently or as separate sub-assemblies. For example, the recoater 42 can be integrated into the multi-function build head 32 as shown in FIG. 7A or it can be provided as a separate assembly. The recoater 42 is discussed in more detail below. The multi-function build head 32 can be a static component that covers the operating radius of the build plate 22 (i.e., build area 26c, which is across the entire space between the walls 26 of the build plate 22) while the build plate 22 rotates and/or can be configured to translate vertically (i.e., up and down in the z-axis) to maintain a desired distance between the multi-function build head 32 and the top layer of the build powder bed in the build area 26c as the build campaign progresses. Additionally, the multi-function build head 32 can also be configured to translate radially across the build area 26c to provide complete coverage of the build area 26c. Regardless of configuration, the build head 32 covers the full build area 26c of the build plate 22 as the build plate 22 rotates and translates down as described above. Although only a single build head 32 is shown in FIGS. 2 and 3, any number of build heads 32 can be used in a particular PBF additive manufacturing system 20. For example, a PBF additive manufacturing system 20 consistent with this disclosure can include 2, 3, 4, or even more build heads 32 spaced at selected intervals. While each of the multiple build heads 32 may be spaced at regular intervals, the build heads may also be spaced at irregular intervals if such a spacing is deemed advantageous. Additionally, a PBF additive manufacturing system 20 consistent with this disclosure can be configured such that the number of build heads 32 can be changed between build campaigns. For example, a single build head 32 can be used for a first build campaign, 3 build heads 32 (or any other number of build heads 32) can be used for a subsequent second build campaign, and so on. The number of build heads 32 used for a particular build campaign can be determined based on the dimensions, complexity, build powder material, and other considerations for the part 24 to be built during the build campaign.

The PBF additive manufacturing system 20 can also include an x-ray computed tomography (CT or CAT) scan system 34, including scan head 34a and detector 34b, as described in more detail below (see FIG. 10) to integrate a continuous inspection process into the disclosed PBF additive manufacturing process. Although only a single CT scan system 34 is shown in FIGS. 2 and 3, any number of CT scan systems 34 can be used in a particular PBF additive manufacturing system 20.

As discussed further below, the PBF additive manufacturing system 20 also includes a controller 36.

FIG. 7A is a more detailed schematic of the multi-function build head 32 discussed above. The multi-function build head 32 provides a number of capabilities that enable the use of annular build plate 22 in a PBF additive manufacturing system 20. The build head 32 includes a powder dispensing mechanism 40, recoater 42, powder heating element 44, gas manifold 46, and optical array 48, which includes an energy source such as a laser or electron beam source. As discussed above, the build head 32 can remain stationary as the annular build plate 22 rotates, can be configured to translate vertically (i.e., up and down in the z-axis) to maintain a desired distance between the multi-function build head 32 and the build powder bed 50 as the build campaign progresses, and/or can be configured to translate radially across the build area 26c. Translating the build head 32 and the optical array 48 in the z-axis and/or radially across the build area 26c can contribute to repeatable consolidation of the part 24.

The powder dispensing mechanism 40 is configured to distribute additional build powder over the part 24 after each portion of the continuous, helical layer is formed on the part 24 in a manner similar to the distribution of build powder in conventional PBF additive manufacturing systems. The recoater 42 spreads the build powder distributed by the powder dispensing mechanism 40 evenly across the powder bed 50 so that each portion of the continuous, helical layer of the part 24 has a desired thickness. As discussed further below, due to the continuous rotation of the annular build plate 22 the continuous, helical layer of part 24 is deposited in a 2D plane having a pitch that reflects the build layer height. The powder heating element 44 heats unconsolidated build powder to facilitate complete, pore-free consolidation of the build powder. Each of the powder dispensing mechanism 40, recoater 42, and powder heating element 44 can be configured to operate similar to their counterparts in conventional PBF additive manufacturing systems.

As discussed above, the recoater 42 can be integrated into the multi-function build head 32 as shown in FIG. 7A or it can be provided as a separate assembly. Regardless of whether the recoater 42 is integrated into a multi-function build head 32 or is provided as a separate assembly, the recoater 42 should account for the rotational nature of the PBF additive manufacturing system 20 of this disclosure. For example, a recoater 42 with a traditional (i.e., “straight across”) configuration as shown in FIG. 7B may not be suitable for the annular, rotating build plate 22 that is the subject of this disclosure. Other recoater 42 configurations, such as those shown in FIGS. 7C and 7D, may be better suited to the annular, rotating build plate 22 that is the subject of this disclosure. FIG. 7C shows a recoater 42 having a single segment positioned at an acute angle relative to an axis A perpendicular to the direction of rotation R of the build plate 22. FIG. 7D shows a recoater 42 having a chevron shape with two individual segments each positioned at an acute angle relative to an axis A perpendicular to the direction of rotation R of the build plate 22. A person of ordinary skill will appreciate that the recoater 42 can also include more than two segments. The acutely angled recoater 42 of FIG. 7C and the chevron-shaped recoater 42 of FIG. 7D can have a sharp edge 43a (FIG. 7E), radiused edge 43b (FIG. 7F), a combination of a sharp edge 43a and radiused edge 43b (e.g., a radiused edge 43b transitioning to a sharp edge 43a transitioning back to a radiused edge 43b) in contact with the powder bed. The recoater 42 can be made with any material appropriate for the application, such as a relatively hard, rigid material (e.g., a metallic material or a natural or artificial elastomer having a relatively high Shore hardness metric), a relatively soft, flexible material (e.g., a natural or artificial elastomer having a lower Shore hardness metric), brush with bristles of a selected hardness or a combination of materials. The material for the recoater 42 can be selected to provide a uniform density of power packing in the build area 26c during build plate 22 rotation. As discussed above, the recoater 42 should be configured to direct excess build powder into the plurality of apertures 26d in the inner radius wall 26a and outer radius wall 26b to be collected in the excess build powder reservoir 26e.

FIGS. 7H to 7J show a hybrid recoater 42 that includes at least two regions, a first region 42a and a second region 42b. Each of the at least two regions 42a, 42b has different mechanical properties selected to provide a desired distribution of build powder over selected portions of the powder bed. For example, the at least two regions 42a, 42b of the recoater 42 can be made from rigid and/or flexible materials, such as a blade or brush with rigid and/or flexible bristles. For some applications, the recoater 42 can include a first region 42a of relatively hard, rigid material and a second region 42b of relatively soft, flexible material. The recoater 42 can have any suitable shape, such as the angled recoater 42 of FIG. 7C or the chevron-shaped recoater of FIGS. 7D, 7G, 7H, and 7J. The recoater 42 may be a unitary structure or, as shown in FIG. 7J, include a frame 42c that provides overall structure to the at least two regions 42a, 42b, which may themselves be part of the unitary structure or may be removable and replaceable features such as blades.

As shown in FIGS. 7H, 7I, and 7J, it may be desirable for the hybrid recoater 42 to use a first region 42a made from a relatively hard, rigid material to distribute build powder over a characterizing feature 24c of part 24 (e.g., a vane of gas turbine engine vane ring) and a second region 42b made from a relatively soft, flexible material to distribute build powder over secondary features 24a, 24b of part 24 (e.g., inner 24a and outer 24b shrouds of a gas turbine engine vane ring). FIG. 7H shows that there can be some overlap between the first region 42a and the second region 42b. The first region 42a made from a relatively hard, rigid material and the second region 42b made from a relatively soft, flexible material can be made any materials that are suitable to provide a uniform density of power packing in the build area 26c during build plate 22 rotation. For example, the first region 42a made from a relatively hard, rigid material can be a metallic material having a suitable Rockwell hardness metric, a natural or artificial elastomer having a relatively high Shore hardness metric (e.g., 80-100 Shore A for a rigid material or 50-75 Shore A for a semi-rigid material), a brush structure with stiff bristles, or another suitable material. The second region 42b made from a relatively soft, flexible material can also be a metallic material with a lower Rockwell hardness metric than the first region 42a made from a relatively hard, rigid material, a natural or artificial elastomer having a relatively low Shore hardness metric (e.g., 5-45 Shore A), or another suitable material. The second region 42b made from a relatively soft, flexible material can also be a brush structure with soft bristles. A person of ordinary skill will recognize that the dimensions (e.g., thickness, shape, etc.) of the at least two regions 42a, 42b also play a role in determining the mechanical properties of the at least two regions 42a, 42b. The descriptions of the materials and dimensions of the at least two regions 42a, 42b are nonlimiting in that the at least two regions 42a, 42b can be made from any materials and have any dimensions that are suitable to provide a uniform density of power packing in the build area 26c during build plate 22 rotation.

In some applications, the recoater 42 can include a first region 42a having mechanical properties selected to provide a honing effect on the characterizing feature 24c of the part 24 to be built on the PBF additive manufacturing system 20. Similarly, the recoater 42 can include a second region 42b having mechanical properties selected to be tolerant of elevation differences associated with secondary features 24a, 24b of the part 24 to be built on the PBF additive manufacturing system 20. Using a recoater 42 having at least two regions 42a, 42b with different mechanical properties can result in less post-processing for the part 24 and can increase the likelihood of a successful build campaign.

The optical array 48 can include one or more energy sources (48a-n) to provide energy to form a melt pool (not shown) in the powder bed 50 that is selectively sintered and consolidated to form the continuous, helical layer of the part 24. The individual energy sources 48a-n can be lasers, such as laser diodes, electron beam sources, or other appropriate energy sources. For many applications, it may be desirable for the optical array 48 to include a plurality of energy sources 48a-n to provide coverage for the entire operative radius of the build plate 22 (i.e., across the entire space between the walls 26 of the build plate 22). As discussed further below, each of the plurality of energy sources 48a-n should be tuned with respect to the radial location of the individual energy sources 48a-n to maintain a consistent melt pool across the radius (i.e., the full build area 26c) of the annular build plate 22.

The gas manifold 46 blows an inert gas across the optical array 48 to diffuse the soot generated from the consolidated material. The inert gas may be nitrogen or any other inert gas suitable for the PBF additive manufacturing environment. The gas manifold 46 should be positioned to dispense inert gas to mitigate contamination to the optical array 48 and melt pool from soot or airborne build powder.

FIG. 8 shows a schematic of the optical array 48 in more detail, including individual energy sources 48a-n. Although, FIG. 8 shows ten individual energy sources, any number (“n”) of individual energy sources may be used-hence, this application uses the nomenclature 48a-n to represent the individual energy sources. The plurality of individual energy sources 48a-n is distributed radially over the build area 26c of the build plate 22 such that the individual energy sources 48a-n irradiate overlapping portions of the build area 26c. The individual energy sources 48a-n may be lasers, such as laser diodes, electron beam sources, or any other energy sources deemed appropriate for use in the PBF additive manufacture system 20. The rotating annular build plate 22 creates a demanding challenge for the optical array 48 due to the varying tangential velocity of the powder bed 50 across the radius of the build plate 22. As can be appreciated, when the annular build plate 22 rotates at a constant velocity the tangential velocity at the inner radius of the powder bed 50 is slower than at the outer radius of the powder bed 50. If the optical array 48 is configured to deliver constant power across the powder bed 50, the powder bed 50 will experience more effective energy at the inner radius than at the outer radius. This phenomenon could result in an inconsistent melt pool across the powder bed 50 radius, leading to inconsistent consolidation of the part 24 across the powder bed 50 radius. Accordingly, the power of the energy sources 48a-n in the optical array 48 should be scaled with respect to radial location to maintain constant effective energy density delivery across the radius of the powder bed 50. This means that the individual energy sources 48a-n in the optical array 48 will have differing power as a function of the location within the optical array 48. Thus, as shown in FIG. 8, individual energy sources closer to the center of the build radius (i.e., closer to the inner radius of the powder bed 50) should be configured to operate at a lower energy level than individual energy sources further from the center of the build radius (i.e., closer to the outer radius of the powder bed 50).

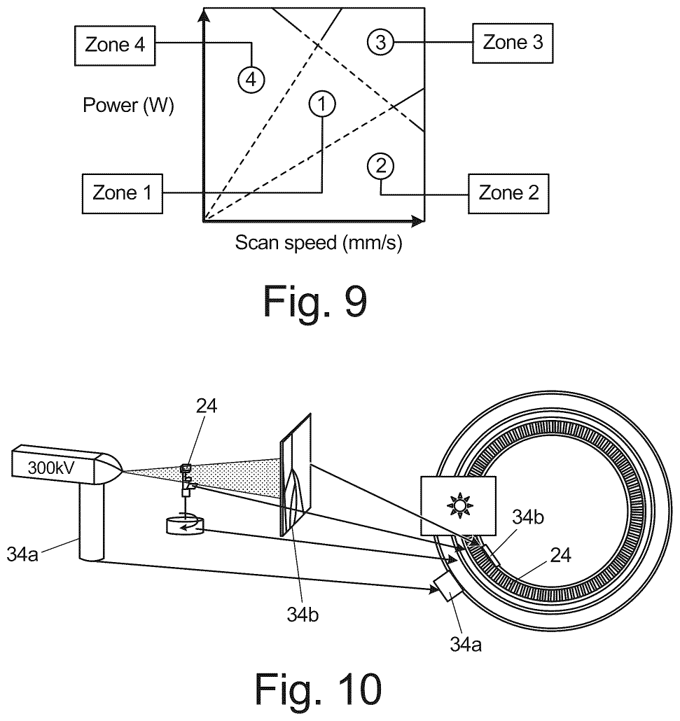

To accommodate the rotational speed of the annular build plate 22, the operating strength for each individual energy source 48a-n in the optical array 48 should be determined based on the rotational speed of the annular build plate 22 and the specific geometry of the part 24 to be built during a specific build campaign. FIG. 9. Shows a notional zone of desirable operating conditions for energy source power versus scan speed of a PBF additive manufacturing system 20 having an annular-shaped build plate 26. Because the multi-function build head 32 and the optical array 48 are generally stationary with regard to the rotating plane of the annular build plate 22, the energy source scan speed should be understood to be the tangential velocity of the build powder bed 50 at the radial location within the “view” of each individual energy source 48a-n in the optical array 48. FIG. 9 shows four zones of potential operation for the energy sources in the optical array 48:
Zone 1: the desired operating zone in which the energy source power is tuned to deliver a desired amount of energy based on scan speed (i.e., local tangential velocity) to melt and fuse the build powder to form fully consolidated layers (the “Just Right” zone)
Zone 2: a zone in which the energy source delivers insufficient energy too quickly in view of the scan speed (i.e., local tangential velocity) such that the local conditions are too cold for desirable melting and fusing of the build powder and layers (the “Too Cold” zone)
Zone 3: a zone in which the scan speed (i.e., local tangential velocity) is too fast to allow the build powder to absorb the energy source energy being delivered to the powder bed, leading to undesirable melting and fusing of the build powder and layers (the “Too Fast” zone)
Zone 4: a zone in which the energy source delivers too much energy in view of the scan speed (i.e., local tangential velocity) such that the local conditions are hot for desirable melting and fusing of the build powder and layers (the “Too Hot” zone)
   As can be appreciated, each energy source 48a-n in the optical array 48 should be tuned to operate within Zone 1 based on the parameters of each specific build campaign.

FIG. 10 is a schematic of an integrated X-ray computed tomography (CT or CAT) scan system 34, including an X-ray emitter or X-ray scan head 34a and an X-ray detector 34b, for use in a PBF additive manufacturing system 20 having an annular-shaped build plate 22. The X-ray scan head 34a includes an X-ray source of suitable power to penetrate the part 24 and side walls 26 of the build plate 22. For example, X-ray source may be 300 kV or any other power level deemed appropriate for the application. The X-ray detector 34b can be any suitable x-ray detector useful in an X-ray CT system that provides sufficient resolution to provide desired information about the part 24 as it progresses through the build campaign. The integrated X-ray CT system 34 works by having an X-ray scan head 34a located after the build head 32 (i.e., “downstream” of the build head 32 in the annular build plate's 22 direction of rotation) on the outer diameter of the annular build plate 22 with an X-ray detector 34b on the inner diameter with a linear path intersecting the part 24 such that the X-ray scan head 34a directs X-ray energy through the part 24 to the X-ray detector 34b. If the PBF additive manufacturing system 20 includes more than one build head 32, the PBF additive manufacturing system 20 can include a single X-ray CT system 34 positioned at an advantageous location with regard to the build plate 22 or may include more than one X-ray CT system 34. The X-ray detector 34b receives X-ray energy as it exits the part 24 to form an image of part 24 that can be examined manually or automatically for defects. The X-Ray CT system 34 can perform imaging of the part 24 in-situ during the build campaign as the annular build plate 22 rotates. If the X-Ray CT system 34 detects defects in the part 24 during the build campaign, the operator can be presented with various options to be implemented manually or automatically through controller 36. These options include varying the build campaign operating parameters as discussed below (e.g., power to individual energy sources 48a-n, rotational speed and/or height of the annular build plate 22, translation of the build head 32, operation of the powder dispensing mechanism 40, operation of the powder heating element 44, or any other operating parameters) to account for the identified defect(s) in the part 24 or, if the defect is serious enough, terminating the build campaign and manually reworking the part 24 or even scrapping the part 24.

The X-Ray CT scanning can also be decoupled from the build process if a final high-resolution scan needs to be taken once excess build powder has been evacuated from the part 24 but with the part 24 still affixed to the annular build plate 22. The post-build X-Ray CT scan could take place at a slower speed and/or higher resolution than might be convenient for the in-process scans discussed above and could form a portion of the final inspection of the part 24. Such an operation permits both in-process inspection of the part 24 during the build campaign and post-build inspection for part 24.

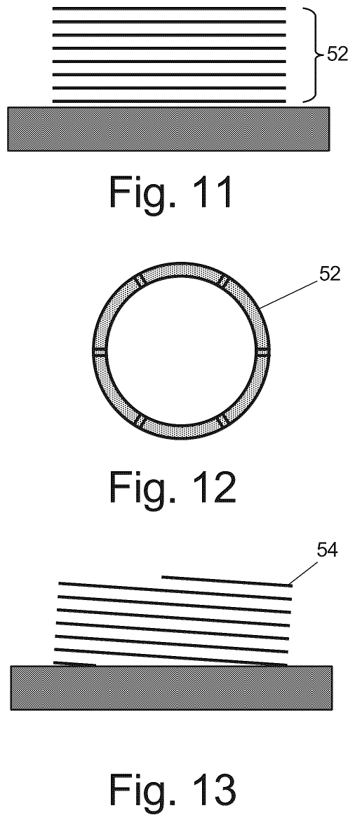

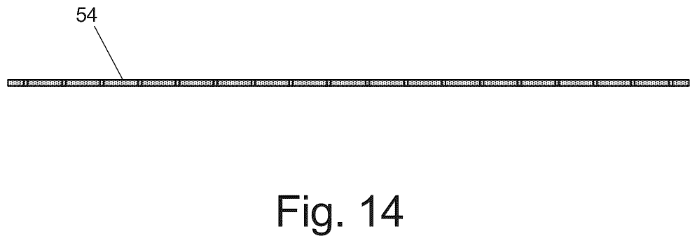

Using a rotating, annular build plate 22 as disclosed results in a unique layer structure in the part 24 compared with parts made with conventional PBF additive manufacturing processes. With a conventional PBF additive manufacturing system, parts have a “stacked” layer configuration as shown schematically in FIGS. 11 (“stacked” layers 52) and 13 (an overhead view of a single layer 52) in which a plurality of individual layers 52 are stacked and consolidated. Each of the plurality of individual layers 52 is oriented “parallel” with the build plate 22 on which the part 24 is formed. Using the disclosed PBF additive manufacturing system 20 with rotating, annular build plate 22 coupled with timed ascent or descent of the build head 32 or annular build plate 22, respectively, the part 24 has a continuous, single layer 54 that is “pitched” with respect to the build plate 22 on which the part 24 is formed. As shown schematically in FIG. 13, the continuous, single layer 54 is helically overlapped on itself across the entire thickness of the part 24 because of the continually rotating build plate 22. The pitch of the continuous, single layer 54 is determined by the height of the build powder layer used for a particular portion of the build campaign and the rotational speed of the rotating, annular build plate 22. If “unwrapped,” the single, helically-distributed layer 54 would form a continuous linear ribbon as shown in FIG. 14. Conceptualizing the single, helically-distributed layer 54 as a continuous linear ribbon can help define the tool path required for the optical array 48 to consolidate the build powder effectively. The curvature of the part 24 is handled by the rotation of the annular build plate 22 and is not part of the energy source scan consideration when determining appropriate power levels for individual energy sources 48a-n in the optical array 48. The single, helically-distributed layer 54 of part 24 should be detectible after consolidation as an artifact of the disclosed PBF additive manufacturing process.

Although not a focus of this disclosure, a person of ordinary skill will recognize that the disclosed PBF additive manufacturing system 20 relies on a controller 36 to control the rotation and height of the annular build plate 22 by rotating and translating the build piston 28, which in turn controls the local thickness and pitch of the continuous, helical layer that forms the part 24. Controller 36 also controls the operation of the build head 32, including the dispensing of build powder from powder dispensing mechanism 40 and the operation of the powder heating element 44, gas manifold 46, and optical array 48 as discussed above. For example, the controller 36 controls PBF system 20 operating parameters, including:
(1) energy source power, velocity, and spot size, build plate temperature, and layer thickness;
(2) temperature-dependent thermophysical properties of the powder;
(3) feedstock properties including average powder particle size; and
(4) energy source hatching strategy including hatch distance, hatch delay time, and stripe width.

The PBF system 20 can be used with a variety of build powders to produce part 24. For example, the powder can be a metal powder or polymeric powder. Metallic powders compatible with typical PBF systems 20 include aluminum, aluminum alloys (e.g., aluminum-lithium alloys), titanium, nickel, nickel alloys, and other metals and alloys known in the art. Polymeric powders compatible with typical PBF systems 20 include a wide variety of polymers as known in the art.

### Discussion of Possible Embodiments

The following are non-exclusive descriptions of possible embodiments of the present invention.

A powder bed fusion (PBF) additive manufacturing system, comprising a powder delivery mechanism configured to deliver build powder to a build area of an annular build plate to form a build powder bed while the annular build plate rotates when the PBF additive manufacturing system is in operation and a recoater configured to provide a uniform density of power packing of the build powder in the build powder bed while the annular build plate rotates when the PBF additive manufacturing system is in operation. The recoater comprises at least one segment positioned at an acute angle relative to an axis perpendicular to a direction of rotation of the annular build plate.

The PBF additive manufacturing system of the preceding paragraph can optionally include, additionally and/or alternatively, any one or more of the following features, configurations and/or additional elements:

A further embodiment of the foregoing PBF additive manufacturing system, wherein the annular build plate further comprises an inner radius wall and an outer radius wall, wherein the inner radius wall and the outer radius wall extend vertically from a junction with the annular build plate to define the build area and inner radius wall and the outer radius wall each include a plurality of apertures that are configured to collect excess build powder and direct the excess build powder through the inner radius wall and outer radius wall to an excess build powder reservoir. The recoater is further configured to direct the excess build powder through the inner radius wall and outer radius wall to the excess build powder reservoir.

A further embodiment of the foregoing PBF additive manufacturing system, wherein the recoater has a chevron shape and comprises two segments that are each positioned at an acute angle relative to an axis perpendicular to a direction of rotation of the annular build plate.

A further embodiment of the foregoing PBF additive manufacturing system, wherein the recoater includes a sharp edge and/or a radiused edge in contact with the build powder bed.

A build head for a PBF additive manufacturing system, comprising a powder delivery mechanism configured to deliver build powder to a build area of an annular build plate to form a build powder bed while the annular build plate rotates when the PBF additive manufacturing system is in operation, a recoater configured to provide a uniform density of power packing of the build powder in the build powder bed while the annular build plate rotates when the PBF additive manufacturing system is in operation, and an optical array positioned over the build area on the build plate. The recoater comprises at least one segment positioned at an acute angle relative to an axis perpendicular to a direction of rotation of the annular build plate. The optical array is configured to project energy onto the build powder bed to form a melt pool in the build powder bed while the annular build plate rotates when the PBF additive manufacturing system is in operation.

The build head for the PBF additive manufacturing system of the preceding paragraph can optionally include, additionally and/or alternatively, any one or more of the following features, configurations and/or additional elements:

A further embodiment of the foregoing build head for the PBF additive manufacturing system, wherein the annular build plate further comprises an inner radius wall and an outer radius wall, wherein the inner radius wall and the outer radius wall extend vertically from a junction with the annular build plate to define the build area and inner radius wall and the outer radius wall each include a plurality of apertures that are configured to collect excess build powder and direct the excess build powder through the inner radius wall and outer radius wall to an excess build powder reservoir. The recoater is further configured to direct the excess build powder through the inner radius wall and outer radius wall to the excess build powder reservoir.

A further embodiment of the foregoing build head for the PBF additive manufacturing system, wherein the recoater has a chevron shape and comprises two segments that are each positioned at an acute angle relative to an axis perpendicular to a direction of rotation of the annular build plate.

A further embodiment of the foregoing build head for the PBF additive manufacturing system, wherein the recoater includes a sharp edge and/or a radiused edge in contact with the build powder bed.

A further embodiment of the foregoing build head for the PBF additive manufacturing system, wherein the optical array comprises a plurality of individual energy sources distributed radially over the build area of the build plate such that the individual energy sources irradiate overlapping portions of the build area, wherein each of the plurality of individual energy sources is a laser or an electron beam source.

A further embodiment of the foregoing build head for the PBF additive manufacturing system, further comprising a build powder preheater configured to preheat build powder after distribution by the recoater and before formation of the melt pool and a gas manifold configured to direct a flow of inert gas across the optical array when the PBF additive manufacturing system is in operation. The build head is configured to translate along a z-axis with respect to the build plate.

A method of operating a powder bed fusion (PBF) additive manufacturing system, comprising providing in the PBF additive manufacturing system a build head comprising a powder delivery mechanism configured to deliver build powder to a build area of an annular build plate to form a build powder bed while the annular build plate rotates when the PBF additive manufacturing system is in operation, a recoater configured to provide a uniform density of power packing of the build powder in the build powder bed while the annular build plate rotates when the PBF additive manufacturing system is in operation, wherein the recoater comprises at least one segment positioned at an acute angle relative to an axis perpendicular to a direction of rotation of the annular build plate, and an optical array positioned over the build area on the build plate, wherein the optical array is configured to project energy onto the build powder bed to form a melt pool in the build powder bed while the annular build plate rotates when the PBF additive manufacturing system is in operation. The powder delivery mechanism delivers build powder to the build area to form a build powder bed while the build plate rotates. A recoater distributes the build powder in the build powder bed to provide uniform density of power packing of the build powder in the build powder bed while the build plate rotates. The optical array positioned over the build area on the build plate directs energy to the build powder in the build powder bed to form a melt pool in the build powder bed while the build plate rotates. The optical array uses energy to selectively sinter build powder from the melt pool to form a layer of a consolidated part while the build plate rotates.

The method for operating a PBF additive manufacturing system of the preceding paragraph can optionally include, additionally and/or alternatively, any one or more of the following features, configurations and/or additional elements:

A further embodiment of the foregoing method, wherein the annular build plate further comprises an inner radius wall and an outer radius wall that extend vertically from a junction with the annular build plate to define the build area. The inner radius wall and the outer radius wall each include a plurality of apertures that are configured to collect excess build powder and direct the excess build powder through the inner radius wall and outer radius wall to an excess build powder reservoir. The method further comprises directing, with the recoater, the excess build powder through the inner radius wall and outer radius wall to the excess build powder reservoir.

A further embodiment of the foregoing method, wherein the recoater has a chevron shape and comprises two segments that are each positioned at an acute angle relative to an axis perpendicular to a direction of rotation of the annular build plate.

A further embodiment of the foregoing method, wherein the recoater includes a sharp edge and/or a radiused edge in contact with the build powder bed.

A further embodiment of the foregoing method, wherein the build head further comprises a build powder preheater and a gas manifold. The method further comprises preheating, with a build powder preheater, the build powder after distribution by the recoater and before formation of the melt pool and directing, with a gas manifold, a flow of inert gas across the optical array to diffuse soot generated from consolidating build powder. The build head translates along a z-axis with respect to the build plate.

A further embodiment of the foregoing method, wherein the optical array comprises a plurality of individual energy sources distributed radially over the build area of the build plate such that the individual energy sources irradiate overlapping portions of the build area, wherein the plurality of individual energy sources comprises a plurality of lasers or a plurality of electron beam sources.

A further embodiment of the foregoing method, further comprising scaling a power of each of the plurality of individual energy sources such that the power of each of the plurality of individual energy sources differs as a function of location within the optical array.

A further embodiment of the foregoing method, wherein the power of each of the plurality of individual energy sources is scaled to deliver constant energy density across a radius of the powder bed while the annular build plate rotates when the PBF additive manufacturing system is in operation.

A further embodiment of the foregoing method, wherein the power of each of the plurality of individual energy sources is lower for individual energy sources closer to an inner radius of the powder bed than for individual energy sources closer to an outer radius of the powder bed while the annular build plate rotates when the PBF additive manufacturing system is in operation.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A powder bed fusion (PBF) additive manufacturing system, comprising:
a powder delivery mechanism configured to deliver build powder to a build area of an annular build plate to form a build powder bed while the annular build plate rotates when the PBF additive manufacturing system is in operation; and
a recoater configured to provide a uniform density of power packing of the build powder in the build powder bed while the annular build plate rotates when the PBF additive manufacturing system is in operation, wherein the recoater comprises at least one segment positioned at an acute angle relative to an axis perpendicular to a direction of rotation of the annular build plate.

2. The PBF additive manufacturing system of claim 1, wherein the annular build plate further comprises:
an inner radius wall and an outer radius wall, wherein the inner radius wall and the outer radius wall extend vertically from a junction with the annular build plate to define the build area and inner radius wall and the outer radius wall each include a plurality of apertures that are configured to collect excess build powder and direct the excess build powder through the inner radius wall and outer radius wall to an excess build powder reservoir;
wherein the recoater is further configured to direct the excess build powder through the inner radius wall and outer radius wall to the excess build powder reservoir.

3. The PBF additive manufacturing system of claim 1, wherein the recoater has a chevron shape and comprises two segments that are each positioned at an acute angle relative to an axis perpendicular to a direction of rotation of the annular build plate.

4. The PBF additive manufacturing system of claim 1, wherein the recoater includes a sharp edge and/or a radiused edge in contact with the build powder bed.

5. A build head for a powder bed fusion (PBF) additive manufacturing system, comprising:
a powder delivery mechanism configured to deliver build powder to a build area of an annular build plate to form a build powder bed while the annular build plate rotates when the PBF additive manufacturing system is in operation;
a recoater configured to provide a uniform density of power packing of the build powder in the build powder bed while the annular build plate rotates when the PBF additive manufacturing system is in operation, wherein the recoater comprises at least one segment positioned at an acute angle relative to an axis perpendicular to a direction of rotation of the annular build plate; and
an optical array positioned over the build area on the build plate, wherein the optical array is configured to project energy onto the build powder bed to form a melt pool in the build powder bed while the annular build plate rotates when the PBF additive manufacturing system is in operation.

6. The build head for PBF additive manufacturing system of claim 5, wherein the annular build plate further comprises:
an inner radius wall and an outer radius wall, wherein the inner radius wall and the outer radius wall extend vertically from a junction with the annular build plate to define the build area and inner radius wall and the outer radius wall each include a plurality of apertures that are configured to collect excess build powder and direct the excess build powder through the inner radius wall and outer radius wall to an excess build powder reservoir;
wherein the recoater is further configured to direct the excess build powder through the inner radius wall and outer radius wall to the excess build powder reservoir.

7. The build head for PBF additive manufacturing system of claim 5, wherein the recoater has a chevron shape and comprises two segments that are each positioned at an acute angle relative to an axis perpendicular to a direction of rotation of the annular build plate.

8. The build head for PBF additive manufacturing system of claim 5, wherein the recoater includes a sharp edge and/or a radiused edge in contact with the build powder bed.

9. The build head for PBF additive manufacturing system of claim 5, wherein the optical array comprises a plurality of individual energy sources distributed radially over the build area of the build plate such that the individual energy sources irradiate overlapping portions of the build area, wherein each of the plurality of individual energy sources is a laser or an electron beam source.

10. The build head for PBF additive manufacturing system of claim 5, further comprising:
a build powder preheater configured to preheat build powder after distribution by the recoater and before formation of the melt pool; and
a gas manifold configured to direct a flow of inert gas across the optical array when the PBF additive manufacturing system is in operation;
wherein the build head is configured to translate along a z-axis with respect to the build plate.

11. A method of operating a powder bed fusion (PBF) additive manufacturing system, comprising:
providing in the PBF additive manufacturing system a build head comprising:
a powder delivery mechanism configured to deliver build powder to a build area of an annular build plate to form a build powder bed while the annular build plate rotates when the PBF additive manufacturing system is in operation;
a recoater configured to provide a uniform density of power packing of the build powder in the build powder bed while the annular build plate rotates when the PBF additive manufacturing system is in operation, wherein the recoater comprises at least one segment positioned at an acute angle relative to an axis perpendicular to a direction of rotation of the annular build plate; and
an optical array positioned over the build area on the build plate, wherein the optical array is configured to project energy onto the build powder bed to form a melt pool in the build powder bed while the annular build plate rotates when the PBF additive manufacturing system is in operation;
delivering, with the powder delivery mechanism, build powder to the build area to form a build powder bed while the build plate rotates;
distributing, with a recoater, the build powder in the build powder bed to provide uniform density of power packing of the build powder in the build powder bed while the build plate rotates;
directing energy, from the optical array positioned over the build area on the build plate, to the build powder in the build powder bed to form a melt pool in the build powder bed while the build plate rotates; and
selectively sintering, using energy from the optical array, build powder from the melt pool to form a layer of a consolidated part while the build plate rotates.

12. The method of operating the PBF additive manufacturing system of claim 11, wherein the annular build plate further comprises an inner radius wall and an outer radius wall, wherein the inner radius wall and the outer radius wall extend vertically from a junction with the annular build plate to define the build area and inner radius wall and the outer radius wall each include a plurality of apertures that are configured to collect excess build powder and direct the excess build powder through the inner radius wall and outer radius wall to an excess build powder reservoir; and the method further comprises:
directing, with the recoater, the excess build powder through the inner radius wall and outer radius wall to the excess build powder reservoir.

13. The method of operating the PBF additive manufacturing system of claim 11, wherein the recoater has a chevron shape and comprises two segments that are each positioned at an acute angle relative to an axis perpendicular to a direction of rotation of the annular build plate.

14. The method of operating the PBF additive manufacturing system of claim 11, wherein the recoater includes a sharp edge and/or a radiused edge in contact with the build powder bed.

15. The method of operating the PBF additive manufacturing system of claim 11, wherein the build head further comprises a build powder preheater and a gas manifold and the method further comprises:
preheating, with a build powder preheater, the build powder after distribution by the recoater and before formation of the melt pool;
directing, with a gas manifold, a flow of inert gas across the optical array to diffuse soot generated from consolidating build powder; and
translating the build head along a z-axis with respect to the build plate.

16. The method of operating the PBF additive manufacturing system of claim 11, wherein the optical array comprises a plurality of individual energy sources distributed radially over the build area of the build plate such that the individual energy sources irradiate overlapping portions of the build area, wherein the plurality of individual energy sources comprises a plurality of lasers or a plurality of electron beam sources.

17. The method of operating the PBF additive manufacturing system of claim 16, further comprising scaling a power of each of the plurality of individual energy sources such that the power of each of the plurality of individual energy sources differs as a function of location within the optical array.

18. The method of operating the PBF additive manufacturing system of claim 16, wherein the power of each of the plurality of individual energy sources is scaled to deliver constant energy density across a radius of the powder bed while the annular build plate rotates when the PBF additive manufacturing system is in operation.

19. The method of operating the PBF additive manufacturing system of claim 16, wherein the power of each of the plurality of individual energy sources is lower for individual energy sources closer to an inner radius of the powder bed than for individual energy sources closer to an outer radius of the powder bed while the annular build plate rotates when the PBF additive manufacturing system is in operation.
